(19) United States
(12) Patent Application Publication
(10) Pub. No.: US 2026/0285437 A1
(43) Pub. Date: Sep. 24, 2026

(54) FOLDABLE MOBILITY SCOOTER

(71) Applicant: Guangdong Prestige Technology Company Limited, Dongguan, Guangdong (CN)

(72) Inventor: Zhao Zhang, Dongguan, Guangdong (CN)

(21) Appl. No.: 19/470,051

(22) PCT Filed: May 24, 2024
(86) PCT No.: PCT/CN2024/095109

§ 371 Date: Sep. 28, 2025

(30) Foreign Application Priority Data
Apr. 17, 2023 (CN) 202320846906.X

(51) Int. Cl. B62K 15/00; B62K 5/007

(52) U.S. Cl. CPC B62K 15/008; B62K 5/007

(57) ABSTRACT

A foldable mobility scooter includes a chassis, a first support rod, a second support rod, a seat base, a swing link, and a latch fastener. The first support rod is pivotally connected to the chassis, and the first support rod is movably connected to the rear end of the seat base. The second support rod and the first support rod are pivotally connected. The upper end of the second support rod is pivotally connected to the front end of the seat base, the lower end of the second support rod is pivotally connected to the swing link which is pivotally connected to the chassis. The latch fastener is provided on the second supporting rod and can be fastened to the chassis when the mobility scooter is unfolded. The foldable mobility scooter has the advantages of easy folding, convenient storage and transportation and low cost.

### FIELD OF THE INVENTION

The present invention relates to a mobility scooter, and more particularly to a foldable mobility scooter.

### BACKGROUND OF THE INVENTION

To facilitate the elderly to go out, mobility scooters have appeared on the market nowadays. These mobility scooters can be divided into two types including non-foldable mobility scooters and foldable mobility scooters. However, both types of mobility scooters have their respective drawbacks. Non-foldable mobility scooters, due to their inability to fold, occupy a large amount of space when not in use, making storage and transportation inconvenient. Although foldable mobility scooters can be folded into a smaller size, making folding, storage, and transportation convenient, their frames are equipped with numerous rod folding mechanisms and locking mechanisms to achieve the folding, resulting in a complex frame structure that is troublesome to assemble and extremely high in overall cost. Thus, these mobility scooters are unaffordable for elderly people with lower economic capacity, leading to a low adoption rate.

### SUMMARY OF THE INVENTION

The objective of the present invention is to provide a foldable mobility scooter that is simple to fold, convenient for storage and transportation, and low in cost.

In order to achieve the above objective, the present invention provides a foldable mobility scooter, comprising a chassis, a first support rod, a second support rod, a seat base, a swing link, and a latch fastener. A lower end of the first support rod is pivotally connected to the chassis, and an upper end of the first support rod is movably connected to a rear end of the seat base. The second support rod and the first support rod are arranged in a crossed manner and are pivotally connected to each other at middle parts thereof. An upper end of the second support rod is pivotally connected to a front end of the seat base, a lower end of the second support rod is pivotally connected to one end of the swing link, and another end of the swing link is pivotally connected to the chassis. The latch fastener is arranged on the second support rod and engaged with and locked to the chassis when the mobility scooter is unfolded.

Compared with the prior art, in the present invention, the first support rod and the second support rod are arranged on the chassis, the first support rod and the second support rod are arranged in a crossed manner and are pivotally connected to each other, the seat base is positioned between the first support rod and the second support rod, and further the swing link is pivotally connected between the chassis and the second support rod, thus the first support rod and the second support rod can be movably unfolded or folded relative to the chassis. In the unfolded state, the first support rod and the second support rod support the seat base, and the latch fastener is locked to the chassis, bringing the entire frame into a stable unfolded state for use. In the folded state, the first support rod and the second support rod move close to the chassis, to achieve a folded state. In such a way, the volume of the entire frame is effectively reduced, thereby facilitating storage and transportation. Furthermore, the folding process is simple and convenient, which requires only controlling one of the first support rod, the second support rod, or the swing link. Additionally, the entire frame has fewer components than existing foldable mobility scooters, making the assembly simpler and thus the cost lower. By this token, it is conducive to widespread adoption and the convenience for the elderly is improved.

Preferably, the latch fastener is pivotally connected to the second support rod, with one end of the latch fastener provided with a hook, and the chassis is provided with an engagement part for engaging with the hook. This facilitates the engagement between the latch fastener and the second support rod, improves the convenience of unfolding and folding operations, and enhances stability and safety during use.

Specifically, the engagement part is a pin.

Preferably, a third support rod is further included; one end of the third support rod is pivotally connected to the upper end of the first support rod, and another end is pivotally connected to the rear end of the seat base. By arranging the third support rod, the upper section of the first support rod, the upper section of the second support rod, the seat base, and the third support rod form a deformable quadrilateral, thereby achieving deformable folding. The structure is simple and the operation is easy.

Preferably, the rear end of the seat base is provided with a sliding slot along a front-rear direction, and the upper end of the first support rod is slidably arranged in the sliding slot via a sliding shaft. By providing the sliding slot and having the first support rod slidably cooperate with the sliding slot, the first support rod, the second support rod, and the seat base form a variable triangular structure, thereby enabling folding. The structure is simple and the operation is convenient.

Preferably, the foldable mobility scooter further a reset member, which is arranged between the second support rod and the latch fastener to keep the latch fastener engaged with the chassis. This prevents the latch fastener from accidentally disengaging from the chassis, avoids accidental folding of the frame, and improves stability and safety during use.

Specifically, the lower end of the second support rod is fixedly provided with a connection base, and the reset member is connected to the connection base. This ensures a stable connection between the reset member, the second support rod, and the latch fastener, thereby preventing interference.

Preferably, the foldable mobility scooter further comprises an elastic member, which is arranged between the swing link and the chassis to keep the swing link in a position it occupies when the mobility scooter is unfolded. This prevents one or more of the first support rod, the second support rod, and the swing link from swinging accidentally, avoids accidental folding of the frame, and thereby improves the stability and safety of the frame when unfolded.

Preferably, the foldable mobility scooter further comprises a steering rod, which is arranged at a front end of the chassis.

Specifically, the foldable mobility scooter further includes a rotating base and a gas spring. The rotating base is rotatably arranged at the front end of the chassis, and the lower end of the steering rod is pivotally connected to the rotating base. The lower end of the gas spring is pivotally connected to the rotating base, and the upper end is pivotally connected to a connecting lug on the steering rod. By providing the gas spring and utilizing its extendable and retractable characteristics, the steering rod, the rotating base, and the gas spring form a variable triangular structure, thereby allowing the steering rod to move close to the chassis to achieve folding, so that the volume occupied by the frame is reduced, thereby improving the convenience of storage and transportation.

### BRIEF DESCRIPTION OF THE DRAWINGS

FIG. 1 is a perspective view of the foldable mobility scooter according to the present invention.

FIG. 2 is another perspective view of the foldable mobility scooter according to the present invention.

FIG. 3 is a side view of the foldable mobility scooter in an unfolded state according to the present invention.

FIG. 4 is an enlarged view of portion A in FIG. 2.

FIG. 5 is a side view showing the swinging state of various rods during folding of the foldable mobility scooter according to the present invention.

FIG. 6 is a side view showing the folded state of the foldable mobility scooter according to the present invention.

### DETAILED DESCRIPTION OF ILLUSTRATED EMBODIMENTS

To elaborate the technical content, structural features, and achieved effects of the present invention, the following description is provided in conjunction with the embodiments and the drawings for a detailed explanation.

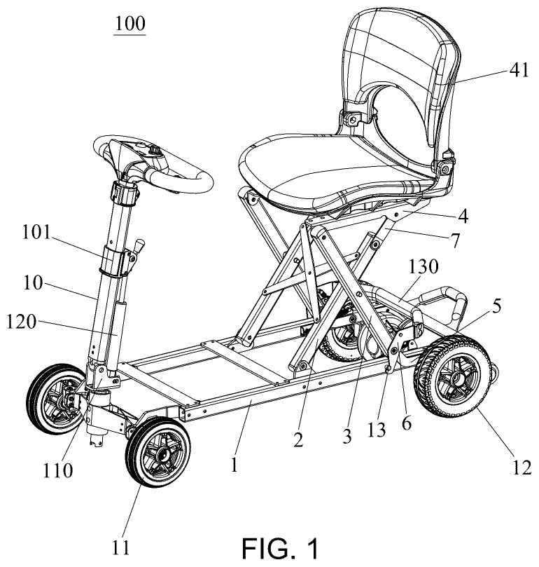

As shown in FIGS. 1 to 3, the foldable mobility scooter 100 of the present invention includes a chassis 1, a first support rod 2, a second support rod 3, a seat base 4, a swing link 5, and a latch fastener 6. The first support rod 2, the second support rod 3, the swing link 5, and the latch fastener 6 are symmetrically arranged on both sides of the chassis 1 to collectively support the seat base 4. The chassis 1 is a fixed frame formed by connecting and securing multiple rods. Front wheels 11 are arranged on opposite sides of the front end of the chassis 1, and rear wheels 12 are arranged on opposite sides of the rear end of the chassis 1. A lower end of the first support rod 2 is pivotally connected to the chassis 1 at a pivot shaft a, and an upper end of the first support rod 2 is movably connected to a rear end of the seat base 4. A backrest plate 41 is pivotally connected to the rear end of the seat base 4. The second support rod 3 and the first support rod 2 are arranged crosswise and pivotally connected to each other at their middle parts via a pivot shaft b. An upper end of the second support rod 3 is pivotally connected to a front end of the seat base 4 at a pivot shaft c. A lower end of the second support rod 3 is pivotally connected to one end of the swing link 5 at a pivot shaft d, which is located rearward of the pivot shaft a. The other end of the swing link 5 is pivotally connected to the chassis 1 at a pivot shaft e. The latch fastener 6 is arranged on the second support rod 3 and can be engaged with and locked to the chassis 1 when the frame is unfolded.

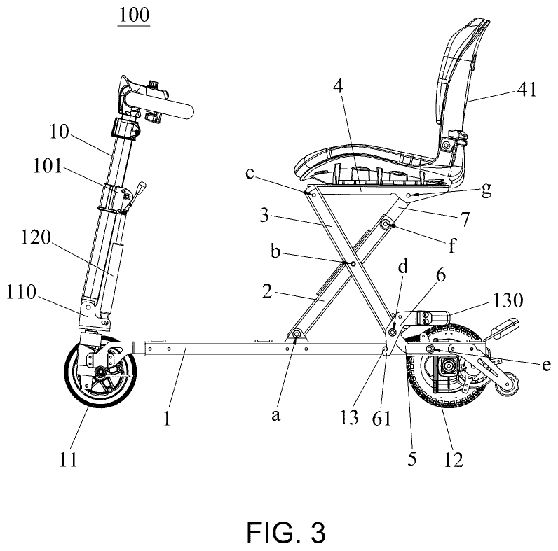

Referring to FIG. 3, the foldable mobility scooter 100 further includes a third support rod 7. One end of the third support rod 7 is pivotally connected to the upper end of the first support rod 2 at a pivot shaft f, and the other end is pivotally connected to the rear end of the seat base 4 at a pivot shaft g. By providing the third support rod 7, an upper section of the first support rod 2, an upper section of the second support rod 3, the seat base 4, and the third support rod 7 form a deformable quadrilateral structure, thereby enabling deformable folding. The structure is simple and the operation is convenient.

As shown in FIG. 3, the latch fastener 6 is pivotally connected to the lower end of the second support rod 3. Specifically, the pivot shaft for the latch fastener 6 on the second support rod 3 is coaxial with the pivot shaft d connecting the second support rod 3 and the swing link 5. One end of the latch fastener 6 is provided with a hook 61, and an outer side of the chassis 1 is provided with an engagement part 13 for engaging with the hook 61. Specifically, the engagement part 13 is a pin, which engages with the hook 61. This facilitates the engagement between the latch fastener 6 and the second support rod 3, improves the convenience of unfolding and folding operations, and enhances stability and safety during use. Furthermore, an operating rod 130 is connected between the two latch fasteners 6 on opposite sides of the chassis 1. By operating the operating rod 130, the latch fasteners 6 can be driven simultaneously to lock or unlock, thereby improving the using convenience.

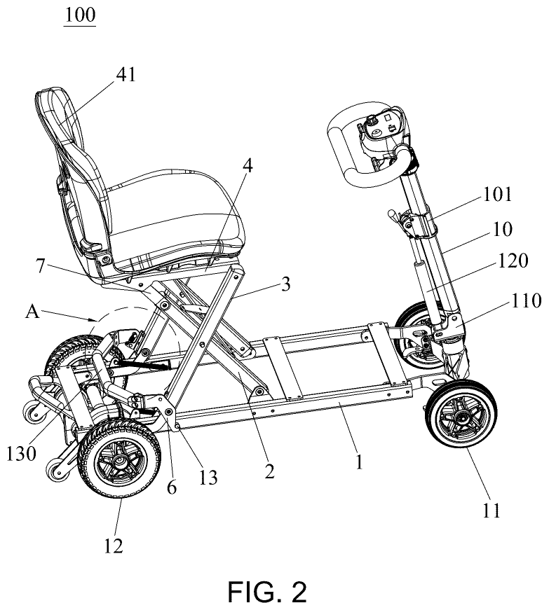

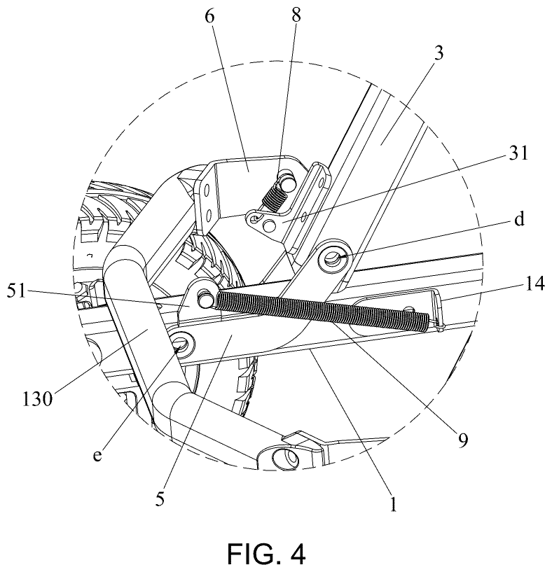

Referring to FIGS. 2 and 4, the foldable mobility scooter 100 further includes a reset member 8 arranged between the second support rod 3 and the latch fastener 6 to keep the latch fastener 6 engaged with the chassis 1. The reset member 8 is a tension spring. In such a way, the latch fastener 6 is prevented from accidentally disengaging from the chassis 1, thereby avoiding accidental folding of the frame, and improving stability and safety during use. Specifically, the lower end of the second support rod 3 is fixedly provided with a connection base 31, and the reset member 8 is connected to the connection base 31. Therefore, a stable connection between the reset member 8, the second support rod 3, and the latch fastener 6 is ensured, thereby preventing the interference.

Referring to FIGS. 2 and 4, the foldable mobility scooter 100 further includes an elastic member 9 arranged between the swing link 5 and the chassis 1 to keep the swing link 5 in the position it occupies when the scooter frame is unfolded. The elastic member 9 is a tension spring. One end of the tension spring is connected to a first lug 51 on the inner side of the swing link 5, and the other end is connected to a second lug 14 on the inner side of the chassis 1. These configurations can prevent one or more of the first support rod 2, the second support rod 3, and the swing link 5 from swinging accidentally, thereby avoiding accidental folding of the frame, and improving the stability and safety of the frame when unfolded.

As shown in FIGS. 1 and 3, the foldable mobility scooter 100 further includes a steering rod 10, a rotating base 110, and a gas spring 120. The steering rod 10 is arranged at the front end of the chassis 1. The rotating base 110 is rotatably arranged at the front end of the chassis 1. A lower end of the steering rod 10 is pivotally connected to the front end of the rotating base 110. A lower end of the gas spring 120 is pivotally connected to the rear end of the rotating base 110, and an upper end of the gas spring 120 is pivotally connected to a connecting lug 101 on the steering rod 10. By providing the gas spring 120 and utilizing its extendable and retractable characteristics, the steering rod 10, the rotating base 110, and the gas spring 120 form a variable triangular structure, thereby allowing the steering rod 10 to move close to the chassis 1 to achieve folding. In such a way, the volume occupied by the frame is reduced and the convenience of storage and transportation are improved.

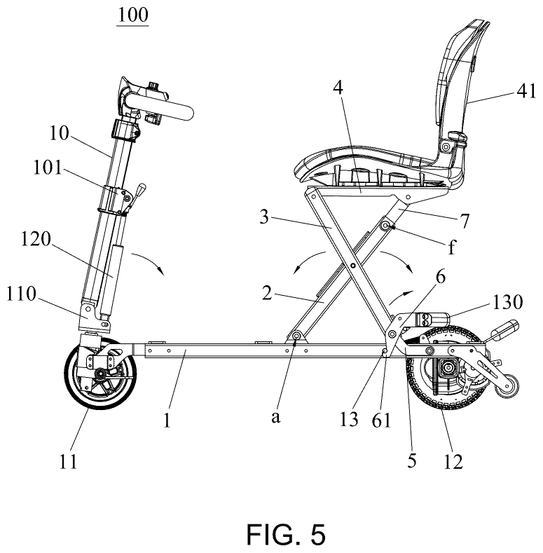

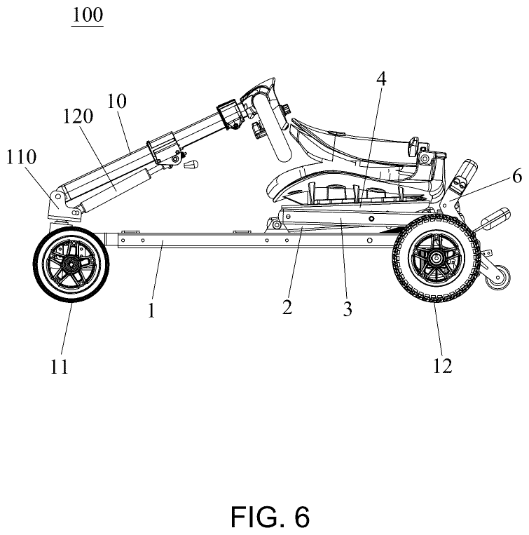

Combining with FIGS. 3, 5, and 6, when folding the foldable mobility scooter 100, the operating rod 130 is first pulled to drive the latch fastener 6 to rotate about the pivot shaft h, causing the hook 61 of the latch fastener 6 to disengage from the pin 13. At this point, the second support rod 3 and the chassis 1 are unlocked. Then, the operating rod 130 is pulled backward, causing the swing link 5 to swing backward about the pivot shaft e, while the lower end of the second support rod 3 also swings backward. Consequently, the first support rod 2 and the second support rod 3 move close to the chassis 1. Simultaneously, the first support rod 2 drives the third support rod 7 to swing. Under the combined action of the first support rod 2 and the third support rod 7, the seat base 4 moves close to the chassis 1. When the first support rod 2, the second support rod 3, and the seat base 4 are completely folded against the chassis 1, the backrest plate 41 is pushed on the seat base 4 to fold toward the seat base 4. Finally, by pressing the gas spring 120, the gas spring 120 is retracted, causing the steering rod 10 to move close to the chassis 1 for folding. At this point, the foldable mobility scooter 100 is completely folded. When unfolding is required, the above operations are reversed, to finally engage the latch fastener 6 with the pin to unfold the foldable mobility scooter 100 into a locked state.

Compared with the prior art, in the present invention, the first support rod 2 and the second support rod 3 are arranged on the chassis 1, the first support rod 2 and the second support rod 3 are arranged in a crossed manner and are pivotally connected to each other, the seat base 4 is positioned between the first support rod 2 and the second support rod 3, and further the swing link 5 is pivotally connected between the chassis 1 and the second support rod 3, thus the first support rod 2 and the second support rod 3 can be movably unfolded or folded relative to the chassis 1. In the unfolded state, the first support rod 2 and the second support rod 3 support the seat base 4, and the latch fastener 6 is locked to the chassis 1, bringing the entire frame into a stable unfolded state for use. In the folded state, the first support rod 2 and the second support rod 3 move close to the chassis 1, to achieve a folded state. This effectively reduces the volume of the entire frame, thereby facilitating storage and transportation. Furthermore, the folding process is simple and convenient, which requires only controlling one of the first support rod 2, the second support rod 3, or the swing link 5. Additionally, the entire frame has fewer components than existing foldable mobility scooters, making the assembly simpler and thus the cost lower. By this token, it is conducive to widespread adoption and the convenience for the elderly is improved.

Furthermore, in another embodiment, the rear end of the seat base 4 is provided with a sliding slot along a front-rear direction, and the upper end of the first support rod 2 is slidably arranged in the sliding slot via a sliding shaft. By providing the sliding slot and having the first support rod 2 slidably cooperate with the sliding slot, the first support rod 2, the second support rod 3, and the seat base 4 form a variable triangular structure, thereby enabling folding. The structure is simple and the operation is convenient.

The above descriptions are merely preferred embodiments of the present invention and are not intended to limit the scope of the application. Any modifications, equivalent substitutions, or improvements made within the spirit and principles of the present invention should be included within the protection scope of the present invention.

1. A foldable mobility scooter, comprising a chassis, a first support rod, a second support rod, a seat base, a swing link, and a latch fastener;
wherein a lower end of the first support rod is pivotally connected to the chassis, and an upper end of the first support rod is movably connected to a rear end of the seat base; the second support rod and the first support rod are arranged in a crossed manner and are pivotally connected to each other at middle parts thereof; an upper end of the second support rod is pivotally connected to a front end of the seat base, a lower end of the second support rod is pivotally connected to one end of the swing link, and another end of the swing link is pivotally connected to the chassis; the latch fastener is pivotally connected to the lower end of the second support rod and engaged with and locked to the chassis when the mobility scooter is unfolded;
wherein a pivot shaft for the latch fastener on the second support rod is coaxial with a pivot shaft connecting the second support rod and the swing link; and an operating rod is connected between two latch fasteners on opposite sides of the chassis.

2. The foldable mobility scooter according to claim 1, wherein one end of the latch fastener is provided with a hook, and the chassis is provided with an engagement part for engaging with the hook.

3. The foldable mobility scooter according to claim 2, wherein the engagement part is a pin.

4. The foldable mobility scooter according to claim 1, further comprising a third support rod, wherein one end of the third support rod is pivotally connected to the upper end of the first support rod, and another end is pivotally connected to the rear end of the seat base.

5. The foldable mobility scooter according to claim 1, wherein the rear end of the seat base is provided with a sliding slot along a front-rear direction, and the upper end of the first support rod is slidably arranged in the sliding slot via a sliding shaft.

6. The foldable mobility scooter according to claim 1, further comprising a reset member, which is arranged between the second support rod and the latch fastener to keep the latch fastener engaged with the chassis.

7. The foldable mobility scooter according to claim 6, wherein the lower end of the second support rod is fixedly provided with a connection base, and the reset member is connected to the connection base.

8. The foldable mobility scooter according to claim 1, further comprising an elastic member, which is arranged between the swing link and the chassis to keep the swing link in a position it occupies when the mobility scooter is unfolded.

9. The foldable mobility scooter according to claim 1, further comprising a steering rod, which is arranged at a front end of the chassis.

10. The foldable mobility scooter according to claim 9, further comprising a rotating base and a gas spring; wherein the rotating base is rotatably arranged at the front end of the chassis, and a lower end of the steering rod is pivotally connected to the rotating base; a lower end of the gas spring is pivotally connected to the rotating base, and an upper end of the gas spring is pivotally connected to a connecting lug on the steering rod.
